(19) United States
(12) Patent Application Publication
(10) Pub. No.: US 2026/0328072 A1
(43) Pub. Date: Oct. 22, 2026

(54) DOWNHOLE POWER GENERATOR AND COMMUNICATION DEVICE

(71) Applicant: HOVEM AS, Oslo (NO)

(72) Inventor: Knut Arne HOVEM, Oslo (NO)

(21) Appl. No.: 19/103,508

(22) PCT Filed: Oct. 10, 2023
(86) PCT No.: PCT/NO2023/060067

§ 371 Date: Feb. 12, 2025

(30) Foreign Application Priority Data
Oct. 20, 2022 (NO) 20221124

(51) Int. Cl. E21B 41/00; E21B 47/18

(52) U.S. Cl. CPC E21B 41/0085; E21B 47/18

(57) ABSTRACT

A method for generating power and communicating of, to and with downhole equipment, utilizing a fluid filled control line (09) with however many wet mate connections required to reach the deepest pipe section in the well, applying pressure pulse telemetry within a fluid filled control line (09) for communication from the surface to a downhole device (21) or from a downhole device (21) to the surface, applying a hydraulic pressure via the control line (09) from the surface to the downhole device (21), adapted to convert the applied pressure into electrical energy, applying electrical energy to benefit downhole equipment.

### TECHNICAL FIELD

The present invention relates to a method for conveying hydraulic energy and pressure pulse signals, using fluid flow in a tube that runs from the surface and is connected to downhole equipment positioned within the deepest pipe section in a wellbore, in particular a wellbore for exploitation of oil and natural gas. The well may be an onshore or offshore well.

### BACKGROUND ART

Due to sensors and measurement devices used in wellbores for oil and gas exploitation different methods are used, for powering these sensors and devices and for communicating of these sensors and devices with the surface. Powering and communicating between the surface and the downhole equipment is still challenging.

Especially, in the the transition from one pipe section to a deeper pipe section.

The data from the completion equipment is evaluated at the surface. Due to the amount of data communicating between the surface and the downhole equipment and due to the lack of a long term and reliable energy source a reliable system and method to deliver power to the downhole equipment and to perform communications with the downhole equipment is necessary and still wanted.

In particular, the industry is still searching for an effective and reliable method for transmitting signal and power between surface and the deepest pipe section downhole.

The challenge with the use of an electrical cable is the need to connect the cable between pipes sections as this connection needs to be made within the wellbore under wet conditions. The reliability of an electric wet mate connection system is still less than desirable. The technology of electromagnetic inductive connection shows promises but requires the industry to change from DC power to AC electric power infrastructure. Meanwhile, the reliability of hydraulic control line operated equipment such as the downhole safety valve is good and the art of constructing a reliable hydraulic wet mate connection system for a tube that can flow fluid is well known.

This powering and communicating with the downhole equipment have become more important and more complex since the well may include discrete productions zones and therefore a need for controlling zone production, isolating zones, monitoring zone and communicating with zones.

Transmitting of data to surface with hydraulic pressure telemetry has been known for a long time and is still actively used today within the area of drilling.

Downhole chemical injection to prevent scale, vax or asphaltene build up within the production tube is a known practice within the industry. Chemical fluids are pumped down a well via a control line. To achieve effective delivery into the well stream, the fluid passes an injection valve. The injection valve has a check feature to prevent ingress of well fluid into the control line. To enable replacing a faulty or plugged injection valve, the control line is ported to a side pocket mandrel that is integral to the production tubing.

The injection valve is a replaceable item and placed inside the pocket. The valve can be replaced with a cable tool. The replacement operation is known as wireline well intervention and the tool that place the valve in the pocket is known as a kick-over tool. Gas lift valves are replaceable by the same method.

Generating electrical power downhole is, for example, taught by A. Green, U.S. Pat. No. 11,041,370 B2. The limitation with this invention is that the hydraulic power is supplied by flow in the well bore so there is no electrical power generated when the well is not flowing. The device is mounted within the bore and may impede for any future well intervention. The need for control and sending signal up and down the well is not addressed.

Other inventions, for example taught by Tubel, US 2016/0168957 A1, address some limitations in the invention thought by Green. A fraction of the electric power generated downhole is used to keep a downhole electric battery charged. Communication with surface is proposed by means of wireless telemetry. The invention taught by Tubel places the power generating device into a side pocket so access to the wellbore is preserved but does not teach how to build the device so that it can be replaced with a wireline kick-over tool.

The generation of electricity is still limited by the well flowing conditions, but the presence of a downhole battery somewhat mitigates this weakness. The need for control and sending signal up and down the well is addressed with wireless telemetry.

Wireless telemetry is an art known within the industry as a method of acoustic telemetry within the steel production pipe or by electromagnetic waves (radio waves) within the formation. To date these methods is regarded as too complex or expensive for permanent long term well application.

Other invention, for example taught by Purkis, US 2011/0290504 A1, are motivated from a practice of giving commands to many downhole tools mounded on a production tube by flowing RFID tags down a control line that runs adjacent to the tools. From this practice comes the invention of utilizing the flow in the control line to generate electric power down hole. But the invention does not show or discuss if or how the usefulness of the control line can extend to flow to other production tubes deeper within the well.

Other inventions, for example taught by Guelat, WO 2020/264082 A1, are also about generating electrical power downhole. Guelat teaches that such a device can be equipped with an inductive coupler and be removable and replaceable with wireline well intervention and known kick over tools.

US 2018/0305999 A1 describes a system for control using a hydraulic fluid includes a hydraulic control line for flowing the hydraulic fluid, a fluid line in fluid communication with the hydraulic control line, a flow controller configured to regulate a flow of the hydraulic fluid in the fluid line, and a piezoelectric device in fluid communication with the hydraulic control line and configured to actuate the flow controller upon receiving a selected flow of the hydraulic fluid.

U.S. Pat. No. 5,839,508 describes a electrical generating apparatus is provided which connects to the production tubing. In a preferred embodiment, this apparatus includes a housing having a primary flow passageway in communication with the production tubing. The housing also includes a laterally displaced side passageway communicating with the primary flow passageway such that production fluid passes upwardly towards the surface through the primary and side passageways. A flow diverter may be positioned in the housing to divert a variable amount of production fluid from the production tubing and into the side passageway. In accordance with an important feature of this invention, an electrical generator is located at least partially in or along the side passageway. The electrical generator generates electricity through the interaction of the flowing production fluid.

WO 2022/006420 describes a wireless multi-stage completions for providing power to and telemetry communication with downhole device(s) are provided. A power generation system can be disposed along a production string to power downhole devices. The power generation system can be driven by annulus fluid flow or production fluid flow and converts the fluid flow to electrical energy.

In the invention the turbine is driven with annulus fluid flow. This limits the position of the power generating device to remain within the upper production tube.

Downhole chemical injection to prevent scale, vax or asphaltene build up within the production tube is a known practice within the industry. Chemical fluids are pumped down a well via a control line. To achieve effective delivery into the well stream, the fluid passes an injection valve. The injection valve has a check feature to prevent ingress of well fluid into the control line The present invention solves the above-mentioned problems as well as reaching the deepest pipe section within the wellbore, as shown in the following:

### SUMMARY OF INVENTION

The present invention describes a system and method to generate electric power from fluid pumped from the surface through a control line or from fluid entering the well. The generated electric power is to benefit of valves, sensors, measurement devices, electrical devices and energy storage devices installed within the deeper pipe sections, for example across the reservoir formation. The present invention system and method can also be used to send signals from downhole to surface and from surface to downhole, using hydraulic pressure pulse telemetry within a control line.

The downhole equipment described can convert hydraulic energy to electrical energy downhole. The downhole equipment can receive signals sent from surface by method of pressure pulse signals within the fluid filled tube. The downhole equipment can send signals to surface by method of pressure pulse signals within the same fluid filled tube. The downhole equipment may share electrical power and communicate with other downhole equipment by means of a local downhole cable network within the same pipe section or integrated within a composite material pipe.

In power generating mode, the electric power generating devices release the fluid from surface into the well flow.

In listening mode, the devices detect a pressure pulse signal within the control line fluid from the surface, convert the signal into data, and pass data to other devices downhole.

In sending mode, the devices convert data into a pressure pulse signal, and generate a pressure pulse signal within the control line fluid to the surface.

At least one electric power generating device may be placed within the sand screen section along the reservoir section. The well fluid is entering the well, passing the sand screen and therefore generating electric power from the well fluid.

The invention and all embodiments are also described in the claims.

### BRIEF DESCRIPTION OF DRAWINGS

FIG. 1 illustrates a schematic drawing of a well according to the state of the art. It may be an open hole, single zone well with a pre-drilled liner and sand control (08).

FIG. 2 illustrates a simple schematic drawing of a well according to the invention. It may be an open hole, single zone well with a pre-drilled liner, sand control and according to the invention with devices (21, 22) within the deepest pipe section in a wellbore, converting hydraulic energy to electrical energy, receiving signals from the surface, sending signals to the surface and sharing electrical power and communicate with other downhole equipment by means of a local downhole cable (23) network within the same pipe section or integrated within a composite material pipe.

FIG. 3 illustrates a simple schematic drawing of a well according to a preferred embodiment of the invention. It may be an open hole, multi zone well with a pre-drilled liner, sand control, open hole packer (10) dividing zones, and according to the invention with devices (21, 22) within the deepest pipe section in a wellbore, converting hydraulic energy to electrical energy, receiving signals from the surface, sending signals to the surface and sharing electrical power and communicate with other downhole equipment by means of a local downhole cable (23) network within the same pipe section or integrated within a composite material pipe.

FIG. 4 illustrates a schematic detailed drawing of the downhole device (21) that communicates and generates electric power via control lines flow from surface, positioned within the lowest most pipe section in the well.

FIG. 5 illustrates a schematic drawing in section view of the position of the power generating device (22), that generates electric power from reservoir flow (41), positioned within a sand screen (08), and of the position of the integrated cable (23).

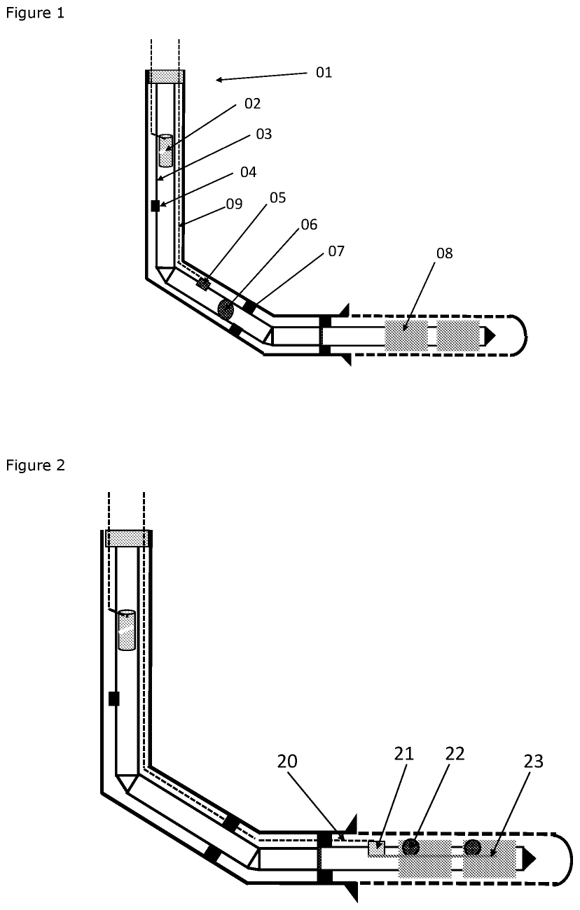

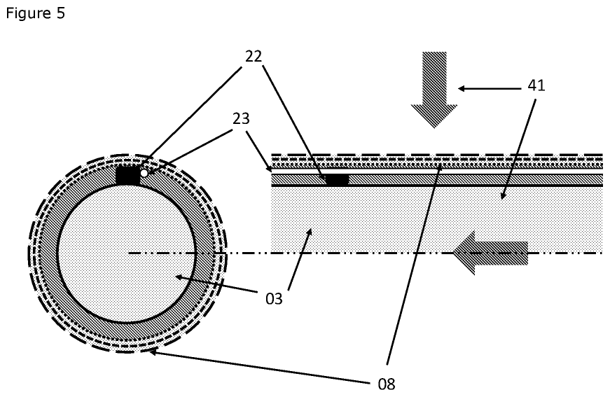

The schematic drawing of FIG. 5 may be from any sand screen positioned within zone A or zone B in FIG. 4.

### REFERENCE LIST

01 tubing hanger with bypass for control lines
02 downhole safety valve with hydraulic control line
03—production tubing
04 gas lift valve, allowing annulus gas to enter tubing
05 state of the art downhole device that generate electric power from control lines flow from surface-Purkis, US 2011/0290504 A1
06 state of the art downhole device that generate electric power from flow from reservoir-Green, U.S. Pat. No. 11,041,370 B2
07 production packer with feed through for hydraulic control lines
08 sand screen preventing sand ingress
09 control line
10 open hole packer dividing Zone A and Zone B
11 inflow control valves controlled from surface with hydraulic control lines
12 downhole flow control valve controlling zone A
13 downhole flow control valve controlling zone B
20 control line and control line flow from/to surface to power the downhole device 21 that generates electric power, also used for communication between uphole and downhole
21 downhole device that generates electric power from control lines flow 20 from surface, positioned within the lowest most pipe section in the well
22 power generating device that generates electric power from flow 41 from reservoir, positioned within a sand screen 08
23 integrated cable to communicate and share power
30 control line (09) with control line port communicating pressure pluses
31 sending unit/also called pulse generating valve
32 listening unit/also called pressure sensor listening signal from surface
33 pump impellers
34 permanent magnets-magnetic field
35 coils rotated with axial
36 slip rings connecting to coil
37 bearing for continuous rotating axial
33-37 power generator
38 excess fluid port into wellbore
39 seal with bypass for rotating axial
41 reservoir/production flow

### DETAILED DESCRIPTION OF THE INVENTION

The present invention describes a system and a method to route a conventional hydraulic control line 09 from the surface down a wellbore and through at least one section of the pipe until reaching that pipe section that is installed across the reservoir formation. At this location adjacent to the reservoir formation, an installed downhole device 21 will generate electric power from fluid pumped from the surface and utilizing the control line 09. The generated electric power is to benefit of valves, sensors, measurement devices, electrical devices and energy storage devices installed within the pipe section across the reservoir formation. The same hydraulic control line 09 used to transport high pressure fluid is also used to send signals from the downhole location to the surface and from the surface to the downhole location. The method of telemetry is hydraulic pressure pulse telemetry within the control line fluid.

FIG. 2 describes some important parts of a well according to the invention. After drilling the well is completed, the completion, according to FIG. 2, typically comprises the tubing hanger 01 with bypass for control lines 09, production packer 07 with feed through for hydraulic control lines 09, and wet mate connection between lower and upper completion.

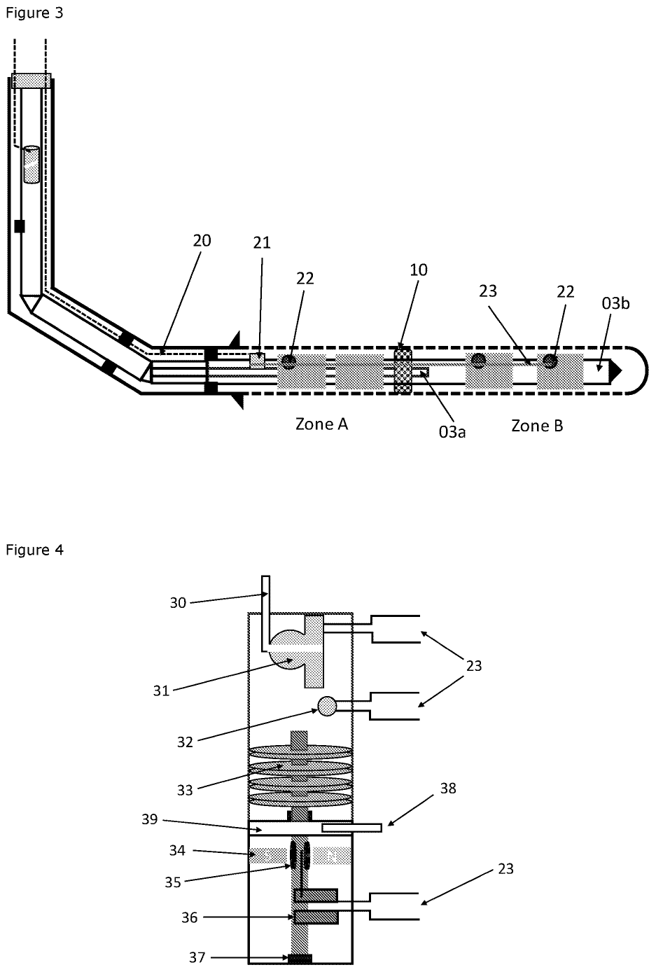

FIG. 3 describes a preferred well according to the invention and a preferred embodiment according to the invention. In use the hydraulic control line 09, 20 transports a high-pressure fluid through the control line from a surface power system to the downhole device 21 in the lower completion, preferred in the deepest pipe section in the wellbore.

In an embodiment, the transport of the high-pressure fluid is utilized through existing chemical injection systems.

When in power generating mode, the downhole device 21 depressurizes the fluid from surface to generate electric power. FIG. 04 shows the downhole device 21 in detail.

The downhole device 21, comprises an upper connection to the control line 09, a control line port 30, providing the high-pressure fluid from the surface. In power generating mode the pulse generating valve of the sending unit 31 is open providing free flow of the high-pressure fluid into the downhole device 21 and for a power generator. pump impellers 33 on an axis, convert the high-pressure flow into rotational energy, electrical state of the art means 34, 35, 36, convert the rotational energy from the axis into electrical energy, cables 23 provide the energy to other devices or energy storage devices. A Fluid Port 38 excess the fluid into the wellbore.

In an embodiment, the generated energy may be conducted to other downhole equipment, such as valves, sensors, measurement devices, electrical devices and energy storage devices by using induction couplers.

In an embodiment, the downhole device 21 may be installed in a side pocket mandrel.

In an embodiment, the downhole device 21 may be replaceable by intervention.

In an embodiment, the energy storage device is located within the downhole device 21.

In listening mode, the listening unit 32 within the downhole device 21 detects a signal from the surface, the power generation may eventually stop and a pressure sensor, eventually equipped with an onboard microprocessor (not shown) converts the data, the pressure pulses, into electric telemetry data that is be passed on to other electrically powered equipment downhole, via the cable 23. A Fluid Port 38 excess the fluid into the wellbore.

When in signal sending mode, the sending unit 31 draws power to generate hydraulic fluid pressure.

In an embodiment the power generator draws power from the device 22 or energy storage devices to generate hydraulic fluid pressure through the sending unit 31 by using the reverse effect of the power generating mode. Electrical energy actuates the impellers 33 creating high pressure fluid flow from the port 38, through the sending unit 31 and the control line 09 to the surface. The sending unit comprises an electric controlled solenoid type valve for generating pressure pulses. The valve within the sending unit 31 can alternate between open and shut position to generate pressure pulses within the fluid in accordance with telemetry code. The signal is detectable at the surface. The embodiment eventually comprises a fluid reservoir (not shown) using the fluid from the reservoir in the sending mode, when creating high pressure fluid flow to the surface.

At least one electric power generating device 22 is placed within the sand screen 08 section along the reservoir section. The fluid entering the well must pass the sand screen 08 and therefore this is the optimum location for an electric power generating device 22 that draws energy from the well fluid flow.

A power generating device 22 comprises an inflow aperture, where the reservoir flow 41 enters the device 22, a state-of-the-art power generator, for example the one from device 21 using impellers 33 on an axis, convert the flow into rotational energy, electrical state-of-the-art means convert the rotational energy to electrical energy, cables 23 provide the energy to other downhole equipment such as valves, sensors, measurement devices, electrical devices and energy storage devices. The flow enters the tubing 03 through an outflow aperture.

In an embodiment, the generated energy may be conducted to other downhole equipment, such as valves, sensors, measurement devices, electrical devices and energy storage devices by using induction couplers.

In an embodiment, the energy storage device is located within the power generating device 22.

In an embodiment the downhole device 21 is divided. The sending and listening unit is placed in a top side pocket mandrel, a power generator unit is placed in a middle side pocket mandrel, an optional fluid reservoir unit is placed in a bottom side pocket mandrel. The embodiment comprises a control line 09, leading from the surface to the top pocket, to the middle pocket, to the bottom pocket, to the wellbore flow, cables 23 communicating or providing the energy to other downhole equipment such as valves, sensors, measurement devices, electrical devices and energy storage devices, optionally an electromagnetic coupler in each pocket, connected to the other devices. The optional fluid reservoir of the embodiment is used in the sending mode, when creating high pressure fluid flow to the surface.

Figures and description may suspect that the invention is for a horizontal well only, but the invention is usable in all kind of wells and types, for example horizontal, vertical, single-zone, multi-zone, open hole, cased hole, etc. . . .

In an embodiment, the fluid pumped down the control line for power can be a chemical and serve in a scale, wax or asphaltene prevention function.

In an embodiment, the fluid pumped down the control line can be water.

In an embodiment, any type of devices placed along the pipe section adjacent to one or multiple reservoir formation can be in communication in an autonomous network.

In embodiments, one or multiple electric power generating devices 22 are placed within one or each sand screen section within the pipe string that is adjacent to the reservoir formation.

In embodiments, one or multiple downhole devices 21 are used.

In an embodiment, the power generated at each screen may be used to calculate the fluid flow rate from the reservoir.

1. A method for generating power and communicating of, to and with downhole equipment, the method comprising the steps of:
utilizing a fluid filled control line (09) with however many wet mate connections required to reach the deepest pipe section (03 b) in the well,
applying pressure pulse telemetry within the fluid filled control line (09) for communication from the surface to a downhole device (21) or from the downhole device (21) to the surface,
applying a hydraulic pressure via the control line (09) from the surface to the downhole device (21), adapted to convert the applied pressure into electrical energy,
applying electrical energy to benefit downhole equipment
where
the applied hydraulic pressure via the control line (09) adapted to generate electrical energy is a hydraulic pressure flow (20), flowing from the surface via the control line (09) into the downhole device (21) actuating a power generator (33-37) within the downhole device (21), generating electrical energy and exiting into the well
the downhole device (21) in listening mode converts hydraulic pressure pulses generated at the surface into digital information to benefit downhole equipment within the wellbore characterized in that
the downhole device (21) in reverse to the generation of electrical energy converts electrical energy to a hydraulic pressure flow, applying pressure pulse telemetry for communication to the surface, and
production flow (41), is adapted to generate electrical energy, flowing from the reservoir or within the tubing (03) into a power generating device (22) placed within a sand screen (08) section along a reservoir section.

2. A method according to claim 1, where the downhole device (21) is located on or within the pipe section adjacent the reservoir formation and that the hydraulic pressure flow (20) from surface is provided by control lines (09) routed longitudinal to however number of pipe sections (03, 03a 03b) adjacent the reservoir formation.

3. A system for generating power and communicating of, to and with downhole equipment, the system comprises:
a downhole device (21) utilizing applied hydraulic pressure via a control line (09) from the surface to convert the applied pressure into electrical energy
a downhole device (21) utilizing pressure pulse telemetry for communication from the surface to the downhole device or from a downhole device to the surface
downhole equipment to benefit from the electrical energy
a power generating device (22) utilizing a reservoir and/or production flow to convert the applied flow into electrical energy
characterized in that
the at least one downhole device (21) comprises:
a connection (30) to the control line (09), providing the hydraulic pressure flow (22) to the device 21,
a sending unit (31), with a pulse generating valve, open in the power generating mode, providing free flow of the high-pressure fluid into the downhole device (21), the pulse generating valve flickering in the sending mode, with cables (23) for communication of power and data with other downhole equipment
a power generator (33-37) comprising pump impellers (33) to convert the hydraulic pressure flow from the control line (09) into rotational energy, electrical means (34-36) to convert the rotational energy into electrical energy,
cables (23) to communicate power and data to other downhole equipment,
a fluid port (38) to excess or to provide the hydraulic pressure flow (20) into the wellbore or into the device (21) and to the surface,
a listening unit (32), detecting signals from the surface, with a pressure sensor, and an onboard microprocessor converting the data, the pressure pulses, into electric telemetry data passed on to other electrically powered equipment downhole,
a pulse generating valve generating pressure pulses within the sending unit (31), where the solenoid valve within the sending unit (31) can alternate between open and shut position to generate pressure pulses within the hydraulic pressure flow (20) in accordance with telemetry code, where the signal is detectable at the surface.
the at least one power generating device (22) comprises:
an inflow aperture, where the reservoir flow (41) enters the device 22,
power generator, converting the flow into electrical energy,
cables (23) providing the energy to other downhole equipment,
an outflow aperture, where the flow enters the tubing (03).

4. The system according to claim 3, comprising induction couplers to power and communicate with other downhole equipment.

5. The system according to claim 1, comprising a fluid reservoir using the fluid from the fluid reservoir in the sending mode, when creating high pressure fluid flow to the surface.

6. The system according to claim 1, where the system is divided into:—a pulse sending and listening unit, placed in a top side pocket mandrel—a generator unit, placed in a middle side pocket mandrel—a fluid reservoir unit, placed in a bottom side pocket mandrel—a hydraulic control line, leading from the surface to the top pocket, to the middle pocket, to the bottom pocket, to the wellbore flow—cables and/or electromagnetic coupler in each pocket, connected to other downhole equipment, where the pulse sending and listening unit, placed in the top side pocket mandrel comprises:—an upper connection to the control line, coming from the surface and providing the high-pressure fluid—a lower connection to the control line, going to the generator unit and providing the high-pressure fluid—a pulse generating valve, generating pressure pulses—a pressure gauge, detecting pressure pulses—an induction coupler, coupled to the solenoid valve and the pressure gauge, to power and communicate with other downhole equipment where the generator unit, placed in a middle side pocket mandrel comprises:—an upper connection to the control line, coming from the lower connection of the pulse sending and listening unit, and providing the high-pressure fluid—a lower connection to the control line, going to the fluid reservoir unit and providing the high-pressure fluid—a cylindrical housing with impellers on an axis-an electrical part within the housing, converting the mechanical energy from the axis to electrical energy—cables and/or electromagnetic coupler, coupled to the electrical part, to power and communicate with other downhole equipment where the fluid reservoir unit, placed in a bottom side pocket mandrel comprises: 13—an upper connection to the control line, coming from the lower connection of the generator unit, and providing the high-pressure fluid—an excess fluid port into the wellbore—a fluid reservoir—a pressure gauge for system control—cables and/or electromagnetic coupler, coupled to the solenoid valve and the pressure gauge, to power and communicate with other downhole equipment.
